(19) United States
(12) Patent Application Publication
(10) Pub. No.: US 2025/0147863 A1
(43) Pub. Date: May 8, 2025

(54) METHOD OF PERFORMING CODE REVIEW AND RELATED SYSTEM

(71) Applicant: MEDIATEK INC., Hsinchu City (TW)

(72) Inventors: Min-Shan Huang, Hsinchu City (TW); Hui-Chi Kuo, Hsinchu City (TW); Wei-Geng Fan, Hsinchu City (TW); Chin-Tang Lai, Hsinchu City (TW); Chiang-Lin Lu, Hsinchu City (TW); Chia-Shun Yeh, Hsinchu City (TW)

(73) Assignee: MEDIATEK INC., Hsinchu City (TW)

(21) Appl. No.: 18/935,662

(22) Filed: Nov. 4, 2024

Related U.S. Application Data
(60) Provisional application No. 63/595,781, filed on Nov. 3, 2023.

(51) Int. Cl. G06F 11/36; G06N 3/0475; G06N 20/20

(52) U.S. Cl. CPC G06F 11/3608; G06N 3/0475; G06N 20/20

(57) ABSTRACT

A method of performing code review and a code review system are provided. The code review system includes a code repository, a static scanning tool, an analytical neural network and a generative neural network. The code repository is configured to store an original source code and a new code created by a developer in response to a code change request to merge the new code with the original source code. The static scanning tool is configured to collect data associated with each commit in the new code. The analytical neural network is implemented with an analytical AI and configured to assess a risk level of each commit in the new code. The generative neural network is implemented with a generative AI and configured to provide a code summarization and an initial code review comment of each commit in the new code.

### CROSS REFERENCE TO RELATED APPLICATIONS

This application claims the benefit of U.S. Provisional Application No. 63/595,781, filed on Nov. 3, 2023. The content of the application is incorporated herein by reference.

### BACKGROUND

Software plays an important role in a variety of application environments such as modern electrical and electronic systems. Software quality plays a prominent role in the overall function, reliability and quality of the entire system. Errors in software design may exist in many different forms, and system failures caused by them may harm human life and safety, require a lot of money to repair, and result in customer dissatisfaction and damage to the company's reputation. Therefore, property software quality management capabilities are essential to the success of a business.

Software code review is the practice that involves team members to systematically check/critique the changes made to an existing software system before the code changes are integrated into the central development, aiming to check the design quality of the code and identify errors to correct them and improve the software quality. Effectively performing code review during software development can identify and correct as many software errors as possible in the software development phase, thereby helping to improve the overall quality of the software and achieving rapid delivery of the software without quality defects.

There are typically two approaches for conducting a code review: manual code review and automatic code review. Manual code review can be carried out by one or more persons in form of, for example, informal walk-through, formal review meetings, pair programming, etc. These activities require a large amount of manpower, and also require the reviewers to be more senior or more experienced than ordinary developers. The use of static analysis tools for automatic code review is also a common method. Based on predetermined quality inspection rules, static analysis tools can quickly scan the source code and identify patterns that are likely to cause software errors, then alert developers in the form of warnings, and provide suggestions on how to fix them. However, violating the predetermined quality inspection rules does not necessarily lead to quality defects. Therefore, static analysis tools often generate a large number of warnings, most of which are false alarms that can be ignored. It still requires a lot of manpower to analyze the results to determine which ones of them are quality defects that really need to be repaired and which ones are merely invalid warnings.

Therefore, there is a need for a system and a method for enhancing code review efficiency and effectiveness with minimal human gatekeeping.

### SUMMARY

The present invention provides a method of performing code review. The method includes receiving a code change request to merge a new code created by a developer with an original source code, collecting data associated with each commit in the new code, assessing a risk level of each commit in the new code using an analytical AI, and providing a code summarization and an initial code review comment of each commit in the new code using a generative AI.

The present invention also provides a code review system which includes a code repository, a static scanning tool, an analytical neural network and a generative neural network. The code repository is configured to store an original source code and a new code created by a developer in response to a code change request to merge the new code with the original source code. The static scanning tool is configured to collect data associated with each commit in the new code. The analytical neural network is implemented with an analytical AI and configured to assess a risk level of each commit in the new code. The generative neural network is implemented with a generative AI and configured to provide a code summarization and an initial code review comment of each commit in the new code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a code review system in accordance with one aspect of the present invention.

FIG. 2 is a flowchart illustrating a method of performing code review in accordance with one aspect of the present invention.

FIG. 3 is a flowchart illustrating a method of performing code review in accordance with another aspect of the present invention.

FIG. 4 is a schematic diagram illustrating the analytical structure of a single commit during the operation of the analytical neural network according to an embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Software and firmware are deployed on computers, portable devices, and electronics. Sometimes, it may be desirable to merge supplemental and/or replacement code (hereafter as “new code”) with the existing original code of the software or firmware. This may be done to change the existing code in some way that resolves a problem. In other cases, the new code may be merged with the original code to add a feature or to improve an existing feature. Any new code needs to be reviewed before being deployed. The following description discloses several preferred aspects of a system and a method for enhancing code review efficiency and effectiveness via hybrid artificial intelligence (AI) solution according to the present invention.

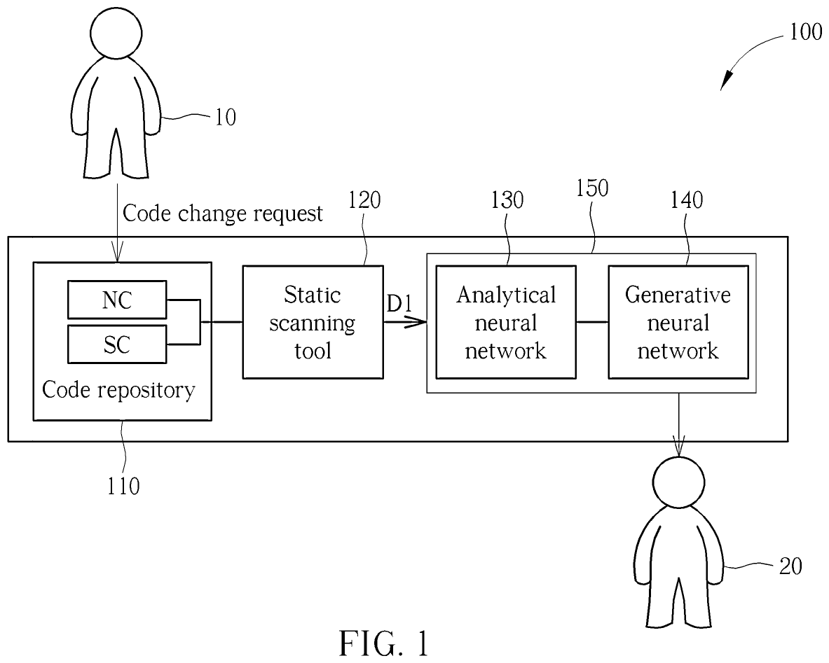

FIG. 1 is a block diagram illustrating a code review system 100 in accordance with one aspect of the present invention. The code review system 100 may be any computer program product at any possible technical detail level of integration, and includes a code repository 110, a static scanning tool 120, and a hybrid AI solution 150 having an analytical neural network 130 and a generative neural network 140.

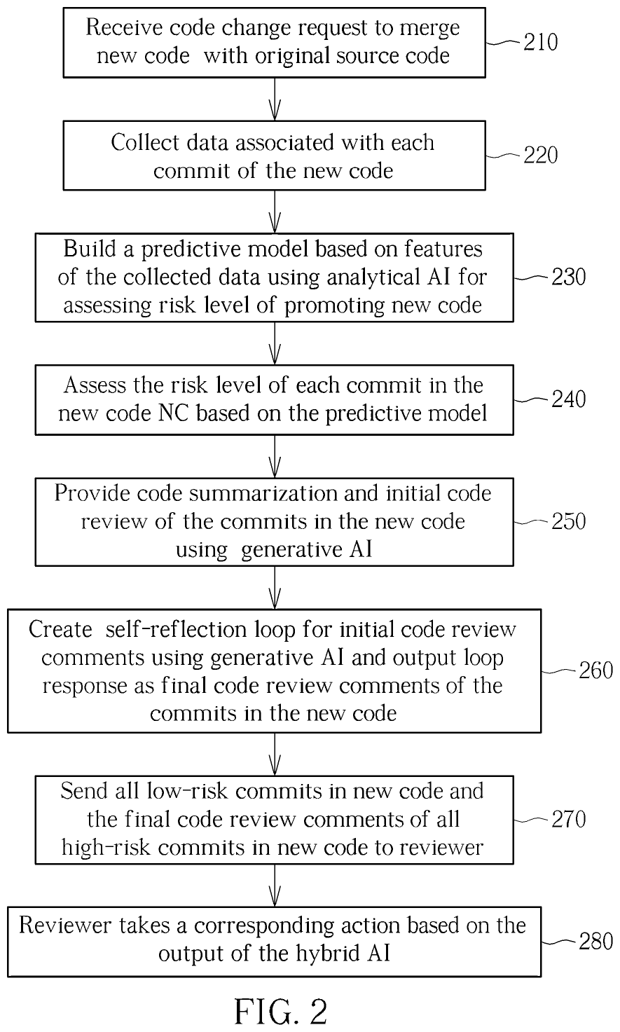

FIG. 2 is a flowchart illustrating a method of performing code review in accordance with one aspect of the present invention. The method depicted in FIG. 2 may be performed by any computer program product at any possible technical detail level of integration (such as the code review system 100 depicted in FIG. 1), and includes the following steps:

| | |
|---|---|
| Step 210: | receive a code change request to merge a new code |
| | NC with an original source code SC. |
| Step 220: | collect data D1 associated with each commit of the |
| | new code NC. |
| Step 230: | build a predictive model based on features of the |
| | collected data D1 using an analytical AI for |
| | assessing a risk level of promoting the new code NC. |
| Step 240: | assess the risk level of each commit in the new code |
| | NC based on the predictive model using the analytical AI. |
| Step 250: | provide code summarization and initial code review |
| | comments of the commits in the new code NC using a |
| | generative AI. |
| Step 260: | create a self-reflection loop for the initial code |
| | review comments using the generative AI and output |
| | the loop response as final code review comments of |
| | the commits in the new code NC. |
| Step 270: | send all low-risk commits in the new code NC and the |
| | final code review comments of all high-risk commits |
| | in the new code NC to a reviewer. |
| Step 280: | the reviewer takes a corresponding action based on |
| | the output of the hybrid AI solution. |

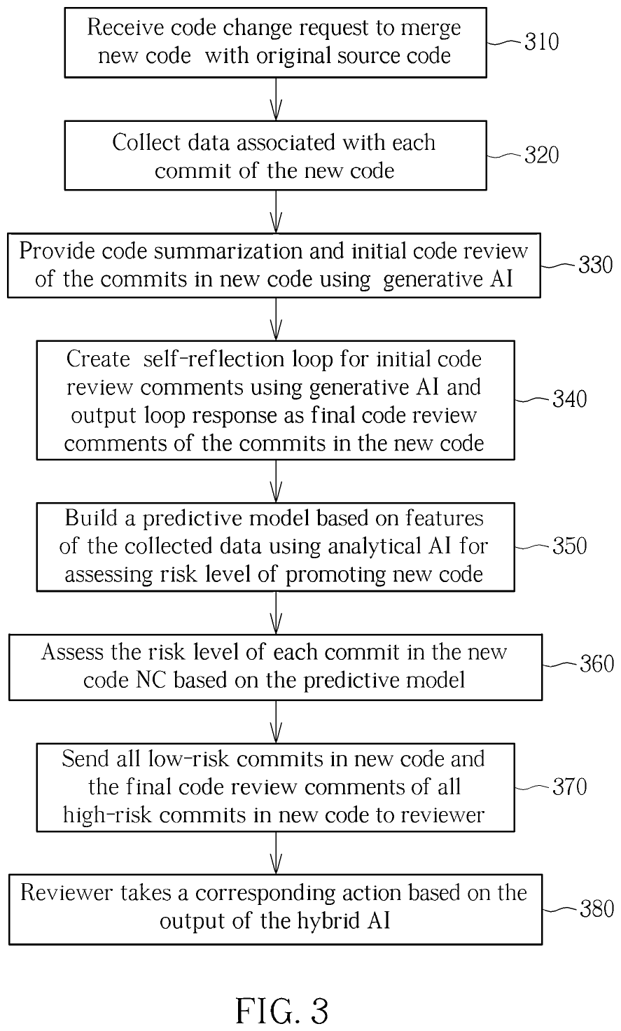

FIG. 3 is a flowchart illustrating a method of performing code review in accordance with another aspect of the present invention. The method depicted in FIG. 3 may be performed by any computer program product at any possible technical detail level of integration (such as the code review system 100 depicted in FIG. 1), and includes the following steps:

| | |
|---|---|
| Step 310: | receive a code change request to merge a new code |
| | NC with an original source code SC. |
| Step 320: | collect data D1 associated with each commit of the |
| | new code NC. |
| Step 330: | provide code summarization and initial code review |
| | comments of the commits in the new code NC using a |
| | generative AI. |
| Step 340: | create a self-reflection loop for the initial code |
| | review comments using the generative AI and output |
| | the loop response as final code review comments of |
| | the commits in the new code NC. |
| Step 350: | build a predictive model based on features of the |
| | collected data D1 using an analytical AI for |
| | assessing a risk level of promoting the new code NC. |
| Step 360: | assess the risk level of each commit in the new code |
| | NC based on the predictive model using the analytical AI. |
| Step 370: | send all low-risk commits in the new code NC and the |
| | final code review comments of all high-risk commits |
| | in the new code NC to the reviewer. |
| Step 380: | the reviewer takes a corresponding action based on |
| | the output of the hybrid AI solution. |

In the present invention, the code review system 100 may include a computer readable storage medium (or media) having computer readable program instructions thereon for causing a processor (not depicted in FIG. 1) to carry out aspects of the present invention. The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

In the present invention, computer readable program instructions described herein may be downloaded to the code review system 100 via a network, for example, the Internet, a local area network, a wide area network and/or a wireless network. Computer readable program instructions for carrying out operations of the present invention depicted in FIG. 2 or FIG. 3 may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages.

Aspects of the present invention are described herein with reference to the block diagram of the code review system 100 depicted in FIG. 1 and the flowcharts depicted in FIGS. 2-3. It will be understood that each step of the flowcharts depicted in FIGS. 2-3 may be implemented by computer readable program instructions stored in the computer readable storage medium of the code review system 100.

These computer readable program instructions may be provided to a processor of the code review system 100 to produce a machine, such that the instructions, which execute via the processor of the code review system 100, create means for implementing each block in the block diagram depicted in FIG. 1 and the functions/acts specified in the flowcharts depicted in FIGS. 2-3. These computer readable program instructions may also be stored in a computer readable storage medium that can direct the code review system 100 to function in a particular manner, such that the computer readable storage medium having instructions stored therein comprises an article of manufacture including instructions which implement aspects of each block in the block diagram depicted in FIG. 1 and the functions/acts specified in the flowcharts depicted in FIGS. 2-3.

The block diagram in FIG. 1 and the flowcharts in FIGS. 2-3 illustrate the architecture, functionality, and operation of possible implementations of the present invention. In this regard, each block in the flowchart or the block diagram may represent a module, segment, or portion of instructions, which comprises one or more executable instructions for implementing the specified logical functions. In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagram and/or the flowchart may be implemented by special purpose hardware-based systems that perform the specified functions or acts or carry out combinations of special purpose hardware and computer instructions.

Moreover, the code review system 100 according to various approaches may include a processor and logic integrated with and/or executable by the processor, the logic being configured to perform one or more steps depicted in FIG. 2 or FIG. 3. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a field programmable gate array (FPGA), etc. Software logic may be stored on local and/or remote memory of any memory type, as well-known in the art. Any processor known in the art may be used, such as a software processor module and/or a hardware processor such as an ASIC, a FPGA, a central processing unit (CPU), an integrated circuit (IC), a graphics processing unit (GPU), etc.

In the embodiment depicted in FIG. 1, the code repository 100 is configured to store the original source code SC created by an author and the new code NC created by a developer 10. In some aspects, the developer 10 may be defined as a person, a team or an entity that creates the new code. In an embodiment, the developer 10 of the new code NC and the author of the original source code SC may be the same individual or different individuals. In an embodiment, the developer 10 may create the new code NC by making modifications to the original source code SC, which may consist of bug fix or a new feature. In an embodiment, the developer 10 may submit the new code NC to the code review system 100 via a code change request, such as a pull request (sometimes also referred to as a merge request), in step 210 or 310.

In the embodiment depicted in FIG. 1, the static scanning tool 120 is configured to statically scan the original source code SC and the new code NC to be evaluated, thereby collecting data DI associated with each commit of the new code NC in step 220 or 320. In an embodiment, the static scanning tool 120 is configured to scan a program code through lexical analysis, syntactic analysis, control flow and data flow analysis and other techniques without running the program code. In an embodiment, the collected data D1 includes one or multiple commits of the new code NC, each of which is a set of changes done to the original source code SC that needs to be reviewed and later integrated to the original source code SC.

In the embodiment depicted in FIGS. 1-3, the hybrid AI solution 150 may assess the risk level of promoting the new code NC using the analytical neural network 130 (steps 230-240 or steps 350-360) and provide code summarization and code review comments of the commits in the new code NC using the generative neural network 140 (steps 250-260 or steps 330-340).

More specifically, in the embodiment depicted in FIG. 2, the analytical neural network 130 implemented with the analytic AI is configured to build the predictive model for assessing the risk level of promoting the new code NC based on features of the collected data D1 (steps 230-240). Next, the generative neural network 140 implemented with the generative AI is configured to provide the code summarization and the code review comments of the commits in the new code NC (steps 250-260). Last, the hybrid AI solution 150 is configured to send all low-risk commits in the new code NC and the final code review comments of all high-risk commits in the new code NC to the reviewer (step 270). In an embodiment, the generative neural network 140 may provide the code summarization and the code review comments of all commits in the new code NC in steps 250-260. In another embodiment, the generative neural network 140 may only provide the code summarization and the code review comments of all high-risk commits in the new code NC in steps 250-260.

Alternatively, in the embodiment depicted in FIG. 3, the generative neural network 140 implemented with the generative AI is configured to provide the code summarization and the code review comments of the commits in the new code NC in steps 330 and 340. Next, the analytical neural network 130 implemented with the analytic AI is configured to build the predictive model for assessing the risk level of promoting the new code NC based on features of the collected data D1 in steps 350-360. Last, the hybrid AI solution 150 is configured to send all low-risk commits in the new code NC and the final code review comments of all high-risk commits in the new code NC to the reviewer (step 370).

The detailed operations of the analytical neural network 130 in the hybrid AI solution 150 in steps 230, 240, 350 and 360 are described hereafter. After performing data analysis on the collected data D1, the analytical neural network 130 may extract meaningful insights by summarizing and visualizing the collected data D1 in an easily understandable format, thereby acquiring the features from the collected data D1 for supporting decision-making in subsequent code review processes. In an embodiment, the analytical neural network 130 is configured to use statistical methods, machine learning algorithms, and data mining techniques to identify patterns, trends, and correlations of the collected data D1, thereby building the predictive model accordingly.

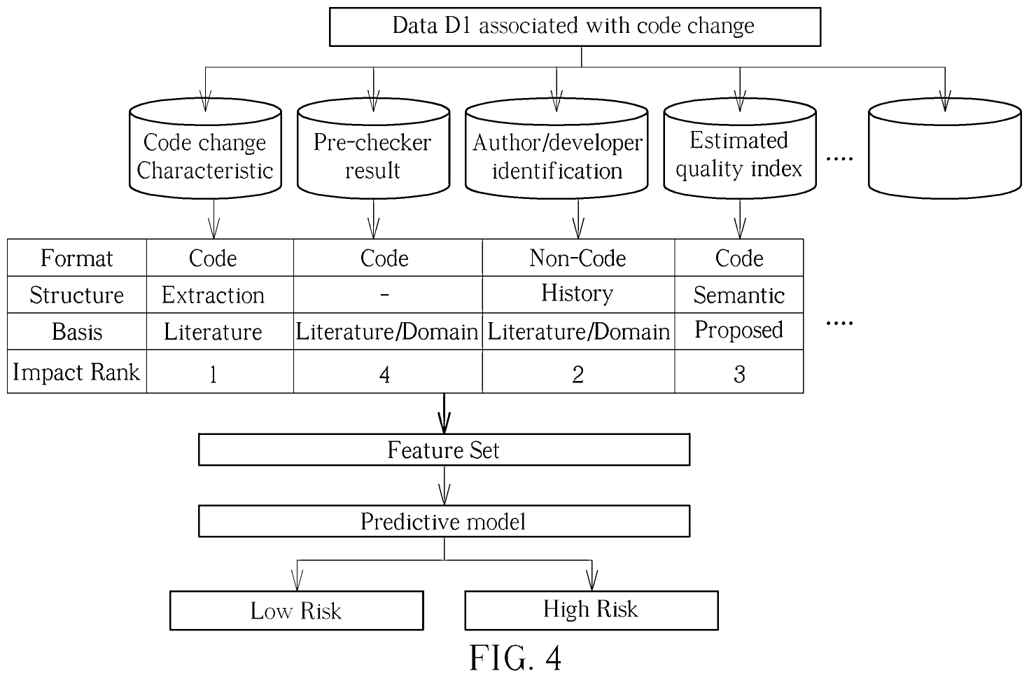

FIG. 4 is a schematic diagram illustrating the analytical structure of a single commit during the operation of the analytical neural network 130 according to an embodiment of the present invention. Other features in the new code NC may be acquired in the same manner. First, the analytical neural network 130 is configured to acquire multiple features of each commit in the collected data D1 in step 230 or 350, such as a code change characteristic, a pre-checker result, an author/developer identification and an estimated quality index, but is not limited thereto.

The code change characteristic may be associated with the difference between the new code NC and the original source code SC. In an embodiment, the analytical neural network 130 may compare the line of code (LOC) matrix of the original source code SC (i.e., all the lines of the original source code SC) to the LOC matrix of the new code NC (i.e., all the lines of the new code NC) for acquiring the line of changed code (LOCC) associated with the code change request. The LOCC associated with the code change request is the number of lines of the original source code SC that have been changed (added, revised or deleted) in a given period of time based on the new code NC.

The pre-checker result indicates whether the new code NC meets indicators including the specifications, security, reliability, and/or maintainability. The analytical neural network 130 may identify error-prone patterns in the collected data D1 arising from the new code NC violating the principle in the original source code SC. For example, an error-prone pattern may include at least one of the following: shotgun surgery, divergent change, big design up front (BDUF), scattered functionality, redundant functionality, cyclic dependency, bad dependency, complex class, long method, code duplication, long parameter list, message chain, and unused method, but is not limited thereto.

The author/developer identification indicates an initial confidence level of the new code NC. Since the author of the original code OC and the developer 10 of the new code NC need to have an in-depth understanding and experience related to the codes they are working with, the author/developer identification may be used to identify the expertise of the author/developer in the related domain of the original code SC/the new code NC. For instance, the author/developer identification may include information related to whether the developer 10 is an authorized person to push the new code NC, how many defects the developer 10 has handled previously and the results of his work, whether and how many review comments have been received regarding the developer 10 and/or his previous new code submissions, and-or how many quality issues have been raised against the developer 10 or fixed by the developer 10. The author/developer identification may be a preliminary indication on the quality of the new code NC.

The estimated quality index may be generated based on one or multiple features of the collected data D1, such as based on the pre-checker result and the author/developer identification.

In an embodiment, the analytical neural network 130 is also configured to identify the details of each feature in the collected data D1. For example, the code change characteristic having a code format is obtained by data extraction and literature-based comparison; the pre-checker result has a code format and is evaluated based on literature/domain; the author/developer identification having a non-code format is obtained based on history and evaluated based on literature/domain; and the estimated quality index having a code format is evaluated based on proposed features and described in semantic. The impact rank of each feature in the collected data D1 may be set based on personal experience and/or historical data, but is not limited thereto.

Next, the analytical neural network 130 is configured to perform dynamic feature selection for finding the best feature set with the most informative features of the collected data D1 in step 230 or 350. For example, the feature set may include the code change characteristic, the pre-checker result, the author/developer identification and the estimated quality index. However, the number and type of feature included in the feature set does not limit the scope of the present invention.

Since most machine learning algorithms are extremely sensitive to the range and distribution of data, the features of each commit in the collected data D1 may be pre-processed before performing dynamic feature selection in step 230 or 350. In an embodiment, the analytical neural network 130 may perform dummy variable processing on the features of each commit in the collected data D1 in order to quantize non-quantifiable variables before performing dynamic feature selection. In another embodiment, the analytical neural network 130 may perform data normalization on the features of each commit in the collected data D1 in order to organize data entries to ensure they appear similar across all fields and records before performing dynamic feature selection. In yet another embodiment, the analytical neural network 130 may perform a discretization procedure on the features of each commit in the collected data D1 in order to group continuous values of variables into contiguous intervals before performing dynamic feature selection. The discretization procedure transforms continuous variables into discrete variables, thereby increasing the efficiency of training models for AI. However, the method of performing data pre-processing in step 230 or 350 does not limit the scope of the present invention.

Next, the analytical neural network 330 is configured to build the predictive model based on the feature set using the analytical AI for assessing the risk level of promoting the new code NC in step 230 or 350. In an embodiment, the analytical neural network 330 may build a machine-learning (ML) tree-based model, such as a random forest model, based on the feature set in step 230 or 350. As well-known to those skilled in the art, the random forest model is based on a commonly-used ML algorithm that combines the output of multiple decision trees to reach a single result. Each decision tree is created based on the feature set and starts with a basic question. These questions make up the decision nodes in the random forest model, acting as a means to split the data. Each question helps an individual to arrive at a final decision, which would be denoted by the leaf node. Observations that fit the criteria will follow the “Yes” branch and those that don't will follow the alternate path. Decision trees seek to find the best split to subset the data, and are typically trained through the Classification and Regression Tree (CART) algorithm. However, the type of the predictive model created in step 230 or 350 does not limit the scope of the present invention.

In step 240 or 360, the analytical neural network 130 is configured to assess the risk level of each commit in the new code NC based on the output of the predictive model created in step 230 or 350. Risk is a measure of how likely a commit is to cause problems, and may be calculated based on the size of the commit, how the changes are spread across the code base and how serious the changes are. The analytical neural network 130 may predict the risk level of each commit in the new code NC using the predictive model created in step 230 or 350. Each commit in the new code NC is labeled as a “high-risk commit” or a “low-risk commit” based on the prediction result of the predictive model.

In the embodiment depicted in FIGS. 1-3, the generative neural network 140 is implemented with the generative AI configured to provide the code summarization and the initial code review comments of the commits or all commits in the new code NC using zero-shot prompting technique. More specifically, the generative neural network 140 is configured to generate a response relying solely on the new code NC without any example or demonstration, thereby providing automatic code review without any human interaction. However, the technique adopted by the generative neural network 140 does not limit the scope of the present invention.

In the embodiment depicted in FIGS. 2-3, after providing the code summarization of the commits in the new code NC in step 260 or 330, the generative neural network 140 is configured to review the code summarization with a predetermined LOC limit. Assuming that the LOC limit is set to 100 lines and a code difference is identified in a specific commit of the new code NC, the generative neural network 140 is configured to submit at most 100 lines prior to the code difference, the content of the code difference and at most 100 lines after the code difference to its generative AI for code review.

In an embodiment when the length of a specific commit in the new code NC exceeds the token limit of the generative AI, the generative neural network 140 is configured to split the specific commit into multiple chunks before analyzing the specific commit.

In step 260 or 340, the generative neural network 140 is configured to create the self-reflection loop for the initial code review comments using the generative AI and output the loop response as final code review comments of the commits in the new code NC. The self-reflection loop represents a paradigm shift, enabling the generative neural network 140 to introspect and refine its processes for enhanced decision-making and accuracy.

In Step 270 or 370, the hybrid AI solution 150 may send all low-risk commits in the new code NC and the final code review comments of all high-risk commits in the new code NC to the reviewer 20. In Step 280 or 380, the reviewer 20 may take a corresponding action based on the output of the hybrid AI solution 150. In some aspects, the reviewer 20 may be defined as a person, a team or an entity with the required expertise to review the new code NC. In an embodiment, the reviewer 20 may decide whether to release the new code NC for deployment based on the output of the hybrid AI solution 150. In another embodiment, the reviewer 20 may provide a feedback to the developer 10 based on the output of the hybrid AI solution 150.

In conclusion, the present invention provides a system and a method capable of enhancing code review efficiency and effectiveness via hybrid AI solution. An analytical AI is implemented for assessing the risk level of each commit in the new code, and a generative AI is implemented for providing code review comments of the commits in the new code. Therefore, the present invention can provide efficient and effective code review with minimal human gatekeeping.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing code review, comprising:
receiving a code change request to merge a new code created by a developer with an original source code;
collecting data associated with each commit in the new code;
assessing a risk level of each commit in the new code using an analytical artificial intelligence (AI);
providing a code summarization and an initial code review comment of each commit in the new code using a generative AI.

2. The method of claim 1, further comprising:
acquiring multiple features of the collected data associated with each commit in the new code using the analytical AI; and
assessing the risk level of each commit in the new code based on the multiple features of the collected data associated with each commit in the new code using the analytical AI.

3. The method of claim 2, wherein acquiring the multiple features of the collected data comprises at least two of following steps:
acquiring a code change characteristic of the collected data associated with a difference between the new code and the original source code using the analytical AI;
acquiring a pre-checker result by identifying an error-prone pattern in the collected data arising from the new code violating a principle in the original source code using the analytical AI;
acquiring a developer identification of the collected data associated with an expertise of the developer in a related domain of the new code using the analytical AI; and
acquiring an estimated quality index of the collected data based on the multiple features of the collected data associated with each commit in the new code using the analytical AI.

4. The method of claim 2, further comprising:
building a predictive model based on the multiple features of the collected data associated with each commit in the new code using the analytical AI; and
assessing the risk level of each commit in the new code based on an output of the predictive model using the analytical AI.

5. The method of claim 4, further comprising:
performing data pre-processing on the multiple features of each commit in the collected data using the analytical AI; and
building the predictive model based on the pre-processed multiple features of the collected data associated with each commit in the new code using the analytical AI.

6. The method of claim 4, wherein performing the data pre-processing comprises at least one of following steps:
performing a dummy variable processing on the multiple features of each commit in the collected data using the analytical AI;
performing a data normalization on the multiple features of each commit in the collected data using the analytical AI; and
performing a discretization procedure on the multiple features of each commit in the collected data using the analytical AI.

7. The method of claim 4, further comprising:
performing a dynamic feature selection for finding a feature set which contains most informative features among the multiple features of each commit in the collected data using the analytical AI; and
building the predictive model based on the feature set using the analytical AI.

8. The method of claim 4, wherein the predictive model is a random forest model.

9. The method of claim 1, further comprising:
creating a self-reflection loop for the initial code review comment of each commit in the new code using the generative AI; and
outputting a loop response as a final code review comment of each commit in the new code using the generative AI.

10. The method of claim 1, further comprising:
providing the code summarization and the initial code review comment of each commit in the new code using a zero-shot prompting technique.

11. The method of claim 1, further comprising:
splitting a specific commit in the new code into multiple chunks when a length of the specific commit exceeds a token limit of the generative AI; and
analyzing the multiple chunks for providing the initial code review comment of the specific commit using the generative AI.

12. A code review system, comprising:
a code repository configured to store an original source code and a new code created by a developer in response to a code change request to merge the new code with the original source code;
a static scanning tool configured to collect data associated with each commit in the new code;
an analytical neural network implemented with an analytical artificial intelligence (AI) and configured to assess a risk level of each commit in the new code; and
a generative neural network implemented with a generative AI and configured to provide a code summarization and an initial code review comment of each commit in the new code.

13. The code review system of claim 12, wherein the analytical neural network is further configured to:
acquire multiple features of the collected data associated with each commit in the new code; and
assess the risk level of each commit in the new code based on the multiple features of the collected data associated with each commit in the new code.

14. The code review system of claim 13, wherein the analytical neural network is further configured to acquire the multiple features of the collected data by performing at least two of followings steps:
acquiring a code change characteristic of the collected data associated with a difference between the new code and the original source code;
acquiring a pre-checker result by identifying an error-prone pattern in the collected data arising from the new code violating a principle in the original source code;
acquiring a developer identification of the collected data associated with an expertise of the developer in a related domain of the new code; and
acquiring an estimated quality index of the collected data based on the multiple features of the collected data associated with each commit in the new code.

15. The code review system of claim 13, wherein the analytical neural network is further configured to:
build a predictive model based on the multiple features of the collected data associated with each commit in the new code; and
assess the risk level of each commit in the new code based on an output of the predictive model.

16. The code review system of claim 15, wherein the analytical neural network is further configured to:
perform data pre-processing on the multiple features of each commit in the collected data; and
build the predictive model based on the pre-processed multiple features of the collected data associated with each commit in the new code.

17. The code review system of claim 15, wherein the analytical neural network is further configured to perform the data pre-processing by performing a dummy variable processing, a data normalization and/or a discretization procedure on the multiple features of each commit in the collected data.

18. The code review system of claim 15, wherein the analytical neural network is further configured to:
perform a dynamic feature selection for finding a feature set which contains most informative features among the multiple features of each commit in the collected data; and
build the predictive model based on the feature set.

19. The code review system of claim 15, wherein the analytical neural network is further configured to build a random forest mode as the predictive model based on the multiple features of the collected data associated with each commit in the new code.

20. The code review system of claim 12, wherein the generative neural network is further configured to:
create a self-reflection loop for the initial code review comment of each commit in the new code; and
output a loop response as a final code review comment of each commit in the new code.

21. The code review system of claim 12, wherein the generative neural network is further configured to:
provide the code summarization and the initial code review comment of each commit in the new code using a zero-shot prompting technique.

22. The code review system of claim 12, wherein the generative neural network is further configured to:
split a specific commit in the new code into multiple chunks when a length of the specific commit exceeds a token limit of the generative AI; and
analyze the multiple chunks for providing the initial code review comment of the specific commit.
